(19) United States
(12) Patent Application Publication
(10) Pub. No.: US 2015/0191079 A1
(43) Pub. Date: Jul. 9, 2015

(54) FLUID TANK WITH MODULAR AND INTERCONNECTED WALL ASSEMBLY

(71) Applicant: Caterpillar Inc., Peoria, IL (US)

(72) Inventors: Thomas A. Meyen, Clinton, IL (US); Jared E. Louis, Monticello, IL (US); Kaushik G. Patel, Rockford, IL (US); Chad C. Stollenwerk, Athens, IL (US); Riley A. Albers, Decatur, IL (US)

(73) Assignee: Caterpillar Inc., Peoria, IL (US)

(21) Appl. No.: 14/662,249

(22) Filed: Mar. 19, 2015

(51) Int. Cl. B60K 15/03; B65D 25/04

(52) U.S. Cl. CPC B60K 15/03006; B65D 25/04

(57) ABSTRACT

A fluid tank with a base assembly, a first wall extension member, and a second wall extension member, is provided. The base assembly includes a base member, a first wall, and a second wall. A first end of the base member is integrally attached to the first wall and a second end of the base member is integrally attached to the second wall. Each of the first wall and the second wall includes a stepped portion and a stiffener portion. The first wall extension member includes a first end with a stepped portion and a second end, which is in a first fitted engagement with the stepped portion of the first wall. The second wall extension member includes a first end with a stepped portion and a second end. The second end is in a second fitted engagement with the stepped portion of the second wall.

### TECHNICAL FIELD

The present disclosure generally relates to fluid tanks. More particularly, the present disclosure relates to a fluid tank with modular and interconnected wall assembly.

### BACKGROUND

Machines, such as earthmoving machines or mining machines, may have one or more fuel tanks to store and facilitate supply of fuel to an engine that powers the machine. Fuel tanks may be generally manufactured separately and then assembled to the machine. It is desirous that fuel tanks meet the requirements of the machine at a work site. As an example, fuel tanks may be subjected to an inertial or gravity load by mass of the fluid contents contained within the fuel tanks. This containment may introduce stresses on walls of the fuel tank, particularly while braking and/or acceleration of the machine, for example. In addition, stresses may be exerted on the walls of the fuel tank due to pressure fluctuations of the fluid contents, which may result in bulging of the walls and an eventual tank failure. This is undesirable for an effective stabilization of the fuel tank.

Conventionally, fuel tanks may be equipped with baffle plates welded on an interior side of opposed walls of the fuel tank. This generally retards a movement of the fluid contents, so as to reduce stresses on the walls of the fuel tanks. For large fuel tanks, the baffle plates may be fabricated to the walls via multiple welds. However, multiple and lengthier welds may weaken the overall durability of the fuel tank when the walls of the fuel tank are subjected to relatively high stresses. In such cases, the welds may crack and result in leakage of the fluid contents.

German patent application number DE102005050803 discloses a fuel tank with partition walls to provide stability to the fuel tank during a surge of the fuel. However, the reference discusses partition walls that are welded internally to the fuel tank, which can be difficult to assemble at the time of manufacture of the fuel tank. In addition, the inner welds may also fail due to the build-up of stresses in the fuel tank.

The present disclosure seeks to address one or more of the problems associated with known fuel tanks.

### SUMMARY OF THE INVENTION

Various aspects of the present disclosure describe a fluid tank for a machine that reduces fluid movement within the fluid tank. The fluid tank includes a base assembly, a first wall extension member, a second wall extension member, a top wall assembly, at least one stiffener panel, a first enclosure panel, and a second enclosure panel. The base assembly includes a base member, a first wall, and a second wall. The first wall is integrally attached to the first end of the base member and extends outwardly. The second wall is integrally attached to the second end of the base member and extends outwardly. Each of the first wall and the second wall includes a stepped portion and a stiffener portion. The first wall extension member includes a first end with a stepped portion and a second end, which is in a first fitted engagement with the stepped portion of the first wall, such that the stiffener portion of the first wall extends outwardly from the first fitted engagement. The second wall extension member includes a first end, with a stepped portion, and a second end, which is in a second fitted engagement with the stepped portion of the second wall, such that the stiffener portion of the second wall extends outwardly from the second fitted engagement. The top wall assembly includes a top wall, a first sidewall, and a second sidewall. The first sidewall is attached to a first end of the top wall and the second sidewall is attached to a second end of the top wall. The first sidewall is in a third fitted engagement with the stepped portion of the first wall extension member. The second sidewall is in a fourth fitted engagement with the stepped portion of the second wall extension member. The stiffener panel includes a first end attached with the base member and a second end attached to the top wall. The first enclosure panel sealably encloses a first side of the fluid tank and the second enclosure panel sealably encloses a second side of the fluid tank.

### BRIEF DESCRIPTION OF THE DRAWINGS

FIG. 1 illustrates a perspective view of a fluid tank with a fragmented enclosure panel to show an interior of the fluid tank, in accordance with the concepts of the present disclosure;

FIG. 2 illustrates a perspective view of the fluid tank of FIG. 1, with an encircled portion to show a stepped portion and a stiffener portion on the interior of the fluid tank, in accordance with the concepts of the present disclosure; and

FIG. 3 shows an enlarged view of the encircled portion of FIG. 2, showing a wall and a wall extension member with the stepped portion and the stiffener portion, in accordance with the concepts of the present disclosure.

### DETAILED DESCRIPTION

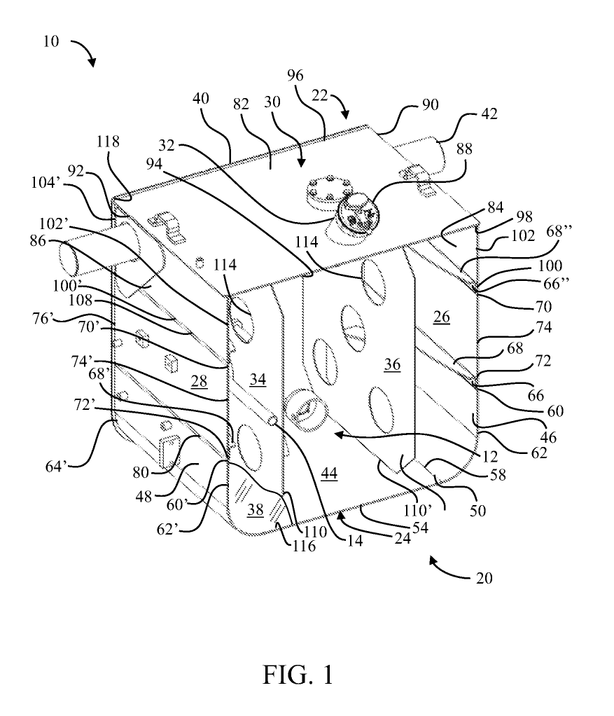

Referring to FIG. 1, there is shown a fluid tank 10 for a machine (not shown). The fluid tank 10 may be mounted to the machine (not shown), that is used to perform one or more of a variety of tasks on a worksite. Fuels, such as diesel fuel, gasoline, and/or the like, may be stored in the fluid tank 10. The fuel stored in the fluid tank 10 is delivered to an internal combustion engine (not shown) of the machine (not shown).

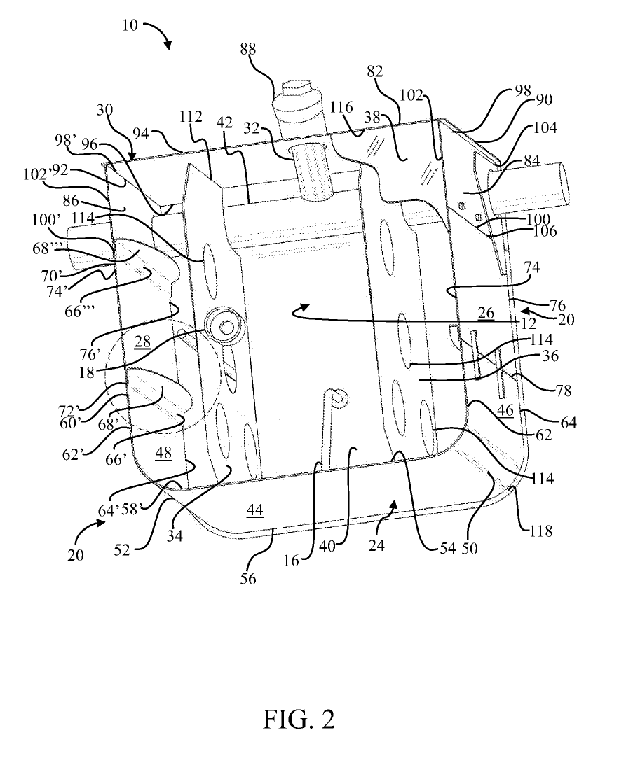

The fluid tank 10 includes an interior portion 12 to contain fuel, such as diesel fuel, gasoline, and/or the like. Further referring to FIG. 2, the interior portion 12 of the fluid tank 10 accommodates a bar member 14, a draw tube 16, and a fuel level sensor 18. The bar member 14 is provided to fix a front side of the fuel tank 10, to close the fuel tank 10. The draw tube 16, positioned in the interior portion 12, may be used to draw the fuel out of the fluid tank 10 to be combusted in the engine (not shown). A level of the fuel contained in the fluid tank 10 is measured by the fuel level sensor 18, which is housed within the interior portion 12 of the fluid tank 10.

Referring to FIG. 1, the fluid tank 10 includes a first side 20 and a second side 22. The first side 20 and the second side 22 are opposite to each other. The first side 20 may be a front side and the second side 22 may be a rear side of the fluid tank 10. The fluid tank 10 includes a base assembly 24, a first wall extension member 26, a second wall extension member 28, a top wall assembly 30, a filler tube 32, a first stiffener panel 34, a second stiffener panel 36, a first enclosure panel 38, a second enclosure panel 40, and a mounting member 42.

The base assembly 24 includes a base member 44, a first wall 46, and a second wall 48. The base member 44 includes a first end 50, a second end 52 (shown in FIG. 2), a third end 54, and a fourth end 56 (shown in FIG. 2). The first end 50 is opposed to the second end 52, and the third end 54 is opposed to the fourth end 56. The first wall 46 includes a first portion 58, a second portion 60, a third portion 62, and a fourth portion 64 (shown in FIG. 2). The first portion 58 is opposed to the second portion 60, and the third portion 62 is opposed to the fourth portion 64.

The first end 50 is integrally attached to the first portion 58 of the first wall 46, such that the first wall 46 extends outwardly in a longitudinal direction substantially perpendicular to the base member 44. The second portion 60 of the first wall 46 includes a stepped portion 66 and a stiffener portion 68. The stepped portion 66 protrudes towards the interior portion 12 of the fluid tank 10. The stepped portion 66 is integrally attached to the stiffener portion 68. The stiffener portion 68 extends away from the first wall 46 and towards the interior portion 12. The stiffener portion 68 is shown as arcuate in shape. In a preferred embodiment of the disclosure, the stepped portion 66 and the stiffener portion 68 are formed features of the first wall 46 of the base assembly 24.

Referring to FIGS. 1-2, the second wall 48 includes a first portion 58′ (shown in FIG. 2), a second portion 60′, a third portion 62′, and a fourth portion 64′. The first portion 58′ is opposed to the second portion 60′, and the third portion 62′ is opposed to the fourth portion 64′. The second end 52 is integrally attached to the first portion 58′ of the second wall 48, which is opposed to the first wall 46. The second wall 48 extends outwardly in a longitudinal direction substantially perpendicular to the base member 44. In an embodiment, the first wall 46 and the second wall 48 may be inclined at other angles relative to the base member 44. The second portion 60′ of the second wall 48 includes a stepped portion 66′ and a stiffener portion 68′. The stepped portion 66′ protrudes towards the interior portion 12 of the fluid tank 10. The stepped portion 66′ is integrally attached to the stiffener portion 68′. The stiffener portion 68′ extends away from the second wall 48 and towards the interior portion 12. The stiffener portion 68′ is shown as parallel to the base member 44, and is arcuate in shape. In an embodiment, the shape of the stiffener portions 68 and 68′ may be triangular or other shape that has the maximum amount of material at center.

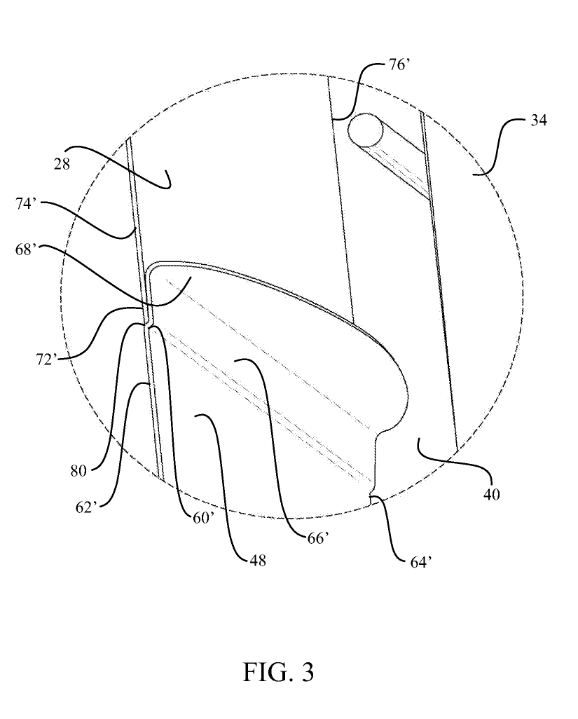

The first wall extension member 26 is positioned on top of the first wall 46. The first wall extension member 26 includes a first end 70, a second end 72, a third end 74, and a fourth end 76 (shown in FIG. 2). The first end 70 is opposed to the second end 72, and the third end 74 is opposed to the fourth end 76. The first end 70 is equipped with a stepped portion 66″ (shown in FIGS. 2-3) and a stiffener portion 68″, which are similar in orientation and structure of the stepped portion 66 and the stiffener portion 68 of the first wall 46. The second end 72 is in a first fitted engagement 78 (shown in FIG. 2) with the stepped portion 66 of the first wall 46, and is continuously welded along a length of the stepped portion 66 and the first fitted engagement 78. This defines the stiffener portion 68 in such a way that the stiffener portion 68 extends outwardly from the first fitted engagement 78.

Referring to FIG. 2, the second wall extension member 28 is positioned on top of the second wall 48. The second wall extension member 28 includes a first end 70′, a second end 72′, a third end 74′, and a fourth end 76′. The first end 70′ is opposed to the second end 72′, and the third end 74′ is opposed to the fourth end 76′. The first end 70′ is equipped with a stepped portion 66″' and a stiffener portion 68″, which are similar in orientation and structure of the stepped portion 66′ and the stiffener portion 68′ of the second wall 48. An encircled portion shows the second end 72′ in a second fitted engagement 80 with the stepped portion 66″' of the second wall 48, and is welded along the stepped portion 66″' and the second fitted engagement 80. This structures the stiffener portion 68′ in such a way that the stiffener portion 68′ extends outwardly from the second fitted engagement 80 (shown in FIG. 3).

As shown in FIGS. 1-2, each of the first wall extension member 26 and the second wall extension member 28 is attached to the top wall assembly 30. The top wall assembly 30 includes a top wall 82, a first sidewall 84, and a second sidewall 86. The top wall 82 is structured to partially accommodate the filler tube 32. The filler tube 32 extends from the top wall 82 towards the interior portion 12 of the fluid tank 10. The filler tube 32 may be used to deliver the fuel to the interior portion 12. The filler tube 32 may be closed by a filler tube cap 88, which is removably secured to the filler tube 32. The filler tube cap 88 may be removed from the filler tube 32 to permit filling of the fluid tank 10.

The top wall 82 includes a first side 90, a second side 92, a third side 94, and a fourth side 96. The first side 90 is opposed to the second side 92, and the third side 94 is opposed to the fourth side 96. The first sidewall 84 includes a first end 98, a second end 100, a third end 102, and a fourth end 104. The first end 98 is opposed to the second end 100 and the third end 102 is opposed to the fourth end 104. The first end 98 of the first sidewall 84 is attached to the first side 90 of the top wall 82, such that the first sidewall 84 extends towards the base assembly 24 in a direction perpendicular to the top wall 82. The second end 100 of the first sidewall 84 is in a third fitted engagement 106 with the stepped portion 66″ of the first wall extension member 26, via welding along the stepped portion 66″ and the third fitted engagement 106. Similarly, the second sidewall 86 includes a first end 98′, a second end 100′, a third end 102′, and a fourth end 104′. The first end 98′ is opposed to the second end 100′, and the third end 102′ is opposed to the fourth end 104′. The first end 98′ of the second sidewall 86 is attached to the second side 92 of the top wall 82, such that the second sidewall 86 extends towards the base assembly 24 in a direction perpendicular to the top wall 82. The second end 100′ of the second sidewall 86 is in a fourth fitted engagement 108 with the stepped portion 66″ of the second wall extension member 28. The second end 100′ and the stepped portion 66′ are held together by welding along the stepped portion 66′ and the fourth fitted engagement 108. It may be contemplated that number and height of the first wall extension member 26 and the second wall extension member 28 may vary depending on the pressure, size, shape, and other factors, for the fluid tank 10.

In addition, the first stiffener panel 34 and the second stiffener panel 36 are confined in the interior portion 12 of the fluid tank 10. The first stiffener panel 34 includes a first end 110 and a second end 112. The second stiffener panel 36 includes a first end 110′ and a second end 112′. The first ends 110 and 110′ of the stiffener panels 34, 36 are attached to the base member 44 and the second ends 112 and 112′ of the stiffener panels 34 and 36 are attached to the top wall 82. In this way, the top wall 82 and the base member 44 are tied via the stiffener panels 34 and 36. The first stiffener panel 34 includes four holes 114 to allow flow of the fuel across the first stiffener panel 34. Similarly, the second stiffener panel 36 includes four holes 114′ to allow the flow of the fuel across the second stiffener panel 36. There may be more than two stiffener panels 34 and 36 within the fluid tank 10. The number of stiffener panels may depend on the shape and size of different fluid tanks.

Further, the first side 20 of the fluid tank 10 is sealably enclosed by the first enclosure panel 38. The first enclosure panel 38 includes a first periphery 116. The first periphery 116 may be in a sealing arrangement with the base assembly 24, the first wall extension member 26, the second wall extension member 28, and the top wall assembly 30, to enclose the first side 20 of the fluid tank 10. The first periphery 116 may be attached to the third ends 54, 74, 74′, 102, and 102′, the third portions 62 and 62′, and the third side 94.

The second side 22 of the fluid tank 10 is sealably enclosed by the second enclosure panel 40. The second enclosure panel 40 includes a second periphery 118. The second periphery 118 is in a sealing arrangement with the base assembly 24, the first wall extension member 26, the second wall extension member 28, and the top wall assembly 30. The second enclosure panel 40 encloses the second side 22 of the fluid tank 10. The second periphery 118 may be attached to the fourth ends 56, 76, 76′, 104, and 104′, the fourth portions 64 and 64′, and the fourth side 96. Further, the second side 22 of the fluid tank 10 includes the mounting member 42, which passes through the first sidewall 84, the stiffener panels 34 and 36, and the second sidewall 86. The mounting member 42 is a tube-like structure which is structured and provided to facilitate attachment of the fluid tank 10 to the machine (not shown).

### INDUSTRIAL APPLICABILITY

In operation, the disclosed fluid tank 10 may be installed in locations of the machine (not shown), that are more easily accessible for installation, repair, and/or fuel fill. A fuel system (not shown) may deliver the fuel to the filler tube 32 of the fluid tank 10, via supply lines (not shown). The fluid tank 10 may be partially or wholly filled with the fuel. While in operation of the machine (not shown), the fuel contained in the fluid tank 10 may slosh against the first wall 46, the second wall 48, the first wall extension member 26, the second wall extension member 28, and/or the top wall 82. Such movement of fuel may result in constant shifting of weight and may exert considerably higher stresses on certain internal surfaces of the fluid tank 10, in an indiscriminate manner. Generally, concentration of the stresses is lesser towards the edges of the fluid tank 10 and higher towards the center of the fluid tank 10. To counter stresses acting towards the center of the wall extension members 26, 28, and the walls 46 and 48, the arc shape of the stiffener portions 68, 68′, 68″, and 68″' are employed, which aids in the distribution and absorption of the stresses. Also, a sequential arrangement of the stiffener panels 34 and 36 with the stiffener portions 68, 68′, 68″, and 68″, structured internally, restricts and reduces the movement of the fuel in the fluid tank 10.

The base assembly 24 is manufactured as a unitary piece with the stiffener portions 68, 68′, 68″, and 68″', and the wall extension members 26 and 28. The wall extension members 26 and 28 are attached on top of the base assembly 24, to meet the rated capacities of the fluid tank 10. There may be more than one wall extension member on each side of the fluid tank 10, in order to tune heights of the stiffener portions 68, 68′, 68″, and 68″'. The above mentioned components are more efficiently assembled so that there is avoidance of internal welding, while facilitating welding of the components from an exterior of the fluid tank 10. With this configuration, both manual and robotic welding may be efficiently performed. In addition, arcuate-shaped stiffener portions 68, 68′, 68″, and 68″' reduce the material needed for manufacturing. Hence, the disclosed fluid tank 10 is comparatively inexpensive and simple to manufacture. Also, the unitary structure of the base assembly 24 and the wall extension members 26 and 28 aids in the achievement of weld reduction in the fluid tank 10. This results in the mitigation of weld failures and leakage possibilities.

Although, in the current embodiment, only two wall extension members are used on each side of the fluid tank 10, multiple number of wall extension members may be employed, based on size of the fluid tank 10 and strength required.

The many features and advantages of the disclosure are apparent from the detailed specification, and thus, are intended by the appended claims to cover all such features and advantages of the disclosure that fall within the true spirit and scope thereof. Further, since numerous modifications and variations will readily occur to those skilled in the art, it is not desired to limit the disclosure to the exact construction and operation illustrated and described herein. Accordingly, all suitable modifications and equivalents may be resorted to that fall within the scope of the disclosure.

What is claimed is:

1. A fluid tank for a machine to reduce fluid movement therewithin, the fluid tank comprising:
a base assembly having a base member, a first wall, and a second wall, a first end of the base member being integrally attached to the first wall and extended outwardly therefrom and a second end of the base member being integrally attached to the second wall and extended outwardly therefrom, the first wall having a stepped portion and a stiffener portion, the second wall having a stepped portion and a stiffener portion;
a first wall extension member having a first end and a second end, the first end of the first wall extension member having a stepped portion and the second end of the first wall extension member being in a first fitted engagement with the stepped portion of the first wall and the stiffener portion of the first wall extended outwardly from the first fitted engagement;
a second wall extension member having a first end and a second end, the first end of the second wall extension member having a stepped portion and the second end of the second wall extension member being in a second fitted engagement with the stepped portion of the second wall and the stiffener portion of the second wall extended outwardly from the second fitted engagement;
a top wall assembly having a top wall, a first sidewall, and a second sidewall, the first sidewall attached to a first end of the top wall and extending therefrom and the second sidewall attached to a second end of the top wall and extending therefrom, wherein the first sidewall being in a third fitted engagement with the stepped portion of the first wall extension member, the second sidewall being in a fourth fitted engagement with the stepped portion of the second wall extension member;
at least one stiffener panel having a first end attached with the base member and a second end attached to the top wall; and
a first enclosure panel and a second enclosure panel, wherein the first enclosure panel sealably encloses a first side of the fluid tank and the second enclosure panel sealably encloses a second side of the fluid tank.
